(19) United States
(12) Patent Application Publication
(10) Pub. No.: US 2021/0367940 A1
(43) Pub. Date: Nov. 25, 2021

(54) AUTHENTICATION SYSTEM FOR PROVIDING BIOMETRICS-BASED LOGIN SERVICE

(71) Applicant: SUPREMA ID INC., Seongnam-si (KR)

(72) Inventors: Won Seok AHN, Yongin-si (KR); Bo Gun PARK, Seoul (KR)

(73) Assignee: SUPREMA ID INC., Seongnam-si (KR)

(21) Appl. No.: 17/393,314

(22) Filed: Aug. 3, 2021

Related U.S. Application Data
(63) Continuation of application No. PCT/KR2020/002015, filed on Feb. 13, 2020.

(30) Foreign Application Priority Data
Apr. 30, 2019 (KR) 10-2019-0050962

(51) Int. Cl. H04L 29/06; G06F 21/62

(52) U.S. Cl. CPC H04L 63/0861; H04L 63/0823; G06F 21/6245

(57) ABSTRACT

The present invention relates to an authentication system for providing a biometrics-based login service, the authentication system comprising: a biometrics authentication server; a target client, and a personal information authentication server, wherein a control method of the personal information authentication server in the authentication system comprises the steps of: checking, before a biometrics authentication process is performed, whether mutual trust exists between the personal information authentication server and the target client; obtaining, after it is determined that mutual trust exists between the personal information authentication server and the target client, biometrics for authentication from the target client; checking whether mutual trust exists between the personal information authentication server and the biometrics authentication server; providing, when it is determined that mutual trust exists between the personal information authentication server and the biometrics authentication server, the biometrics for authentication to the biometrics authentication server; obtaining a personal information protection key for unlocking protection of personal information that corresponds to the target client; and decrypting the personal information.

### TECHNICAL FIELD

The following embodiments relate to an authentication system for providing a biometrics-based login service.

### DESCRIPTION OF THE RELATED ART

Technologies of utilizing various signals or data that can be extracted from a living body and using these signals or data in various systems are developing. In particular, biometric authentication technologies that build security systems using biometric information are in the limelight. For example, the biometric authentication technologies extract signals or information associated with biometric from users, compare the extracted signals or information with pre-stored information, and authenticate users by confirming that the users are themselves.

In addition, such biometric authentication technologies may be implemented on a network. For example, a biometric information recognizer that recognizes biometric information may authenticate a user through communication with a server. In more detail, the biometric information recognizer encrypts biometric information acquired from users and then transmits the encrypted biometric information to the server that stores the pre-registered biometric information, and the server decrypts the encrypted biometric information acquired from the biometric information recognizer and then compares the decrypted biometric information with the pre-registered biometric information to authenticate the users. In this case, according to the related art, there is a problem in that there is no reliability confirmation procedure between servers or devices that exchange information with each other, and thus it is not possible to prevent other devices or servers that do not have access rights, or that important data is intensively stored in a specific server, and thus user data may be exposed to attackers in a vulnerable state when a server browsing authority is stolen or misused without approval from a user.

Accordingly, in recent years, efforts have been made to implement a method of more safely protecting data of a server, and in particular, protecting user data from being misused without approval from a user by using biology authentication technology on a network.

### DISCLOSURE OF THE INVENTION

### Technical Goals

An aspect is to provide a user authentication method and device for more safely providing an online service through a reliability confirmation procedure between servers or devices of an online system.

### Technical Solutions

According to an aspect, there is provided a method of controlling a personal information authentication server in an authentication system, wherein the authentication system includes a biometric information authentication server that stores biometric information for registration acquired from each of one or more clients and performs matching between biometric information for authentication and the biometric information for registration, a target client that is included in the one or more clients and acquires the biometric information for authentication of a user, and a personal information authentication server that stores pieces of personal information acquired by each of the one or more clients, the method comprises: confirming mutual reliability with the target client before performing a biometric information authentication procedure; acquiring the biometric information for authentication from the target client after the mutual reliability with the target client is confirmed; confirming mutual reliability with the biometric information authentication server; providing the biometric information for authentication to the biometric information authentication server such that the biometric information authentication procedure is performed on the biometric information authentication server when the mutual reliability with the biometric information authentication server is confirmed; acquiring a personal information protection key from the biometric information authentication server for releasing protection of personal information corresponding to the target client among the pieces of stored personal information when the authentication is completed in the biometric information authentication procedure; and releasing the protection of the personal information using the personal information protection key or authenticating a right to use such that the personal information is confirmed by a server or a device in which the mutual reliability with the personal information authentication server is confirmed.

According to another aspect, there is provided a method of controlling a biometric information authentication server in an authentication system, wherein the authentication system includes a biometric information authentication server that stores biometric information for registration acquired from each of one or more clients and performs matching between biometric information for authentication and the biometric information for registration, a target client that is included in the one or more clients and acquires the biometric information for authentication of a user, and a personal information authentication server that stores personal information acquired by each of the one or more clients, the method comprises: confirming mutual reliability with the target client before performing a biometric information authentication procedure; confirming mutual reliability with the personal information authentication server before performing a biometric information authentication procedure; acquiring the biometric information for authentication, a biometric information decryption key, and a biometric identifier after the mutual reliability between the target client and the personal information authentication server is confirmed; decrypting the biometric information by extracting the biometric information for registration corresponding to the biometric identifier when the reliability of the personal information authentication server is confirmed; determining whether the extracted biometric information for registration and the biometric information for authentication match; and providing a personal information decryption key to the personal information authentication server when it is determined that the biometric information for registration and the biometric information for authentication match.

The means for solving problem of the present invention is not limited to the above-described solution means, and solution means not mentioned above may be clearly understood by those of ordinary skill in the technical field to which the present invention belongs from the present specification and the accompanying drawings.

### Effects

According to the present disclosure, it is possible for a user to safely perform a user authentication process through biometric information on a network.

According to the present invention, it is possible to double security by performing a reliability confirmation procedure between components of a network system and then performing authentication using biometric information.

According to the present invention, it is possible to safely and conveniently authenticate a user using biometric information.

According to the present invention, it is possible to make personal information and biometric information safer than when they are managed on one server by preventing the biometric information and the personal information from being stored and decrypted together and allowing the personal information and the biometric information to play a complementary role in protecting the other's data.

According to the present invention, it is possible to easily disconnect or connect a connection relationship between a biometric information authentication server or a personal information authentication and storage server depending on a client's reliability policy, and minimize a ripple effect when security incidents occur because each server cannot decrypt and use biometric information or personal information stored alone,

### BRIEF DESCRIPTION OF THE DRAWINGS

FIG. 1 is a diagram illustrating an overall configuration of an authentication system according to an embodiment.

FIG. 2 is a diagram illustrating a relationship between a client, a personal information authentication server, and a biometric information authentication server according to an embodiment.

FIG. 3 is a diagram for describing a method of confirming reliability according to an embodiment.

FIG. 4 is a diagram illustrating an authentication procedure according to an embodiment.

FIG. 5 is a diagram illustrating an authentication process by an authentication system according to an embodiment.

### DETAILED DESCRIPTION FOR CARRYING OUT THE INVENTION

The above-described objects, features, and advantages of the present invention will become more obvious from the following detailed description provided in relation to the accompanying drawings. However, the present invention may be variously modified and have several exemplary embodiments. Therefore, specific embodiments will be illustrated in the accompanying drawings and described in detail.

In the drawings, thicknesses of layers and regions are exaggerated for clarity. In addition, when an element or a layer is said to be “on” another element or layer, it includes cases in which another layer or element is interposed between the elements or layers as well as the case in which it is directly on another element or layer. Throughout the specification, the same reference numerals refer to the same elements in principle. Further, same reference numerals will be used for designation like components having same functions throughout the drawings within the scope of the present invention.

When it is decided that a detailed description for a known function or configuration related to the present invention may obscure the gist of the present invention, the detailed description thereof will be omitted. In addition, numbers (for example, first, second, etc.) used in the description of the present specification are merely identification symbols for distinguishing one element from other elements.

The terms “module” and “unit” used for elements in the following description are used only to make the disclosure easier to understand. Therefore, these terms do not have meanings or roles in themselves that distinguish the elements from each other.

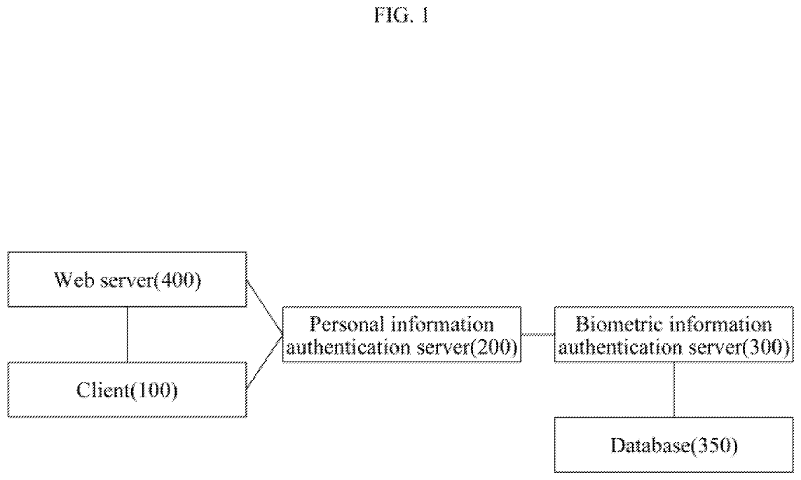

FIG. 1 is a diagram illustrating an overall configuration of an authentication system according to an embodiment.

Referring to FIG. 1, an authentication system 1 may include a client 100, a personal information authentication server 200, a biometric information authentication server 300, and a web server 400.

The client 100 may be a device that acquires biometric information or personal information, requests user authentication from an external device or a server based on the acquired information, and acquires an authentication result or information on the authentication result according to the user authentication request, and at least one client 100 may exist in the authentication system 1.

In some embodiments, the client may be a biometric information recognizer that directly acquires biometric information from a user or may be a terminal that acquires the biometric information from the biometric information recognizer. In addition, the client may be a terminal that directly acquires personal information from a user.

In one embodiment, the biometric information recognizer is a device for acquiring biometric information. For example, the biometric information recognizer may include a sensor that detects the biometric information. For example, the biometric information may include user's fingerprint information, electrocardiogram (ECG) information, electromyography (EMG) information, iris information, blood vessel information, vein information, voice information, face information, palm read information, etc., and the sensor represents a device that detects at least one type of biometric information among the biometric information.

In one embodiment, the terminal acquiring personal information may be any electronic device including a device capable of receiving a user input.

In one embodiment, the personal information is unique information of each user who uses the client 100, and may be information that is not desirable to be leaked. For example, the personal information may be unique information of a user including a resident registration number, personal contact information, an address, a sex, medical data, and the like of the user. In addition, in the present disclosure, the personal information may be a biometric identifier used for classifying biometric information in a biometric information authentication server or data to verify validity of the biometric identifier. Examples of data for verifying the validity of the biometric identifier include a unique number of the biometric information authentication server, a biometric information registration time, and a certificate issued by the personal information authentication server, and the like.

In addition, in one embodiment, the personal information may include not only personal information on an individual who has accessed the client and alphanumeric information that can prove economic or social activity, but also data that can confirm whether the biometric information confirmed by the biometric information authentication server matches information on an individual stored in the personal information server.

In addition, the client 100 may be defined as a device that requests user authentication or service provision from the personal information authentication server 200, the biometric information authentication server 300, or the web server 400 of the authentication system.

Requesting the service provision may mean logging in to a server, and requesting the user authentication may mean a procedure of accessing the server for login.

The personal information authentication server 200 may protect personal information obtained by at least one client 100 by storing it in advance, or provide the stored personal information to the web server 400 or the like where the user wants to receive a service through an authentication procedure. Here, the pre-stored personal information may be expressed as personal information for registration, and the personal information for registration may serve as standard information for authenticating a user and may be provided to the web server 400 or another client 100 for authentication for authentication. In addition, personal information of each user acquired from each client 100 may be protected by a unique key of the client 100 from the client 100 and stored in the personal information authentication server 200. The protection of the protected personal information may be released from the personal information authentication server 200. In addition, as will be described below, a decryption key for the biometric information for registration may be obtained from the client 100 and stored in the personal information authentication server 200.

Here, the meaning of “protection” may be understood as a broader concept than general data encryption and decryption. “Protection” may refer to protecting by encrypting all or a part of data to be protected. In addition, releasing the protection may refer to releasing the protection by decrypting all or a part of the encrypted data.

In addition, “protection” may refer to a method of setting or controlling an authorization procedure for accessing data, such as accessing data or reading data, without encrypting the data to be protected. By controlling the authority to access the data, an effect of the data protection similar to that of data encryption may be derived.

In addition, the “protection” may be a combination of a method of controlling an authorization procedure for accessing all or a part of the encrypted data in addition to a method of encrypting all or a part of data to be protected. As a result, the double data protection effect of encryption and access authority setting for the data to be protected may be derived.

In addition, it will be understood that all methods that are obvious to those skilled in the art may be used so that the effect of preventing unexpected leakage of data may be derived.

In addition, the personal information authentication server 200 may serve as a server that directly provides a service to a user. As will be described below, the web server 400 and the personal information authentication server 200 are classified according to roles that each server plays in the authentication system 1, and the personal information authentication server 200 and the web server 400 may perform the same/similar operations, may have the same/similar functions, and may include the same/similar configurations.

The biometric information authentication server 300 may be defined as a server that pre-stores the biometric information from at least one client and performs a user authentication procedure on the biometric information. Here, the pre-stored biometric information may be expressed as the biometric information for registration and may serve as reference information for authenticating a user. In addition, the pre-stored biometric information may be encrypted from each client 100 and stored in the biometric information authentication server 300. The encrypted biometric information may be decrypted in the biometric information authentication server 300.

In addition, the biometric information authentication server 300 may store a personal information protection key for releasing the protection of personal information that is stored and protected in the personal information authentication server 200.

The biometric information authentication server 300 may acquire the personal information protection key from the client 100. In this case, the biometric information authentication server 300 may acquire a personal information decryption key from the client 100 through the personal information authentication server 200. In addition, in some cases, the biometric information authentication server 300 may directly acquire the personal information protection key from the client 100.

The biometric information authentication server 300 may include an additional database 350. Encrypted biometric information for registration may be stored in the database 350. For security, physical security equivalent to HSM may be set in the database 350.

As a method related to the data protection, the data encryption, or the authentication procedure by a certificate that will be described in the present invention or described below, a method related to a private key or a symmetric key may be used.

Examples of the symmetric key include triple data encryption standard (3EDS), advanced encryption standard (AES), SEED, Academy, research Institute, Agency (ARIA) data encryption standards (DES), CRYPTON, RUNDAEL, CAST256, RCS, RC5, RC4, RC2, TWOFISH, MARS, SERPENT, SKIPJACK, international data encryption algorithm (IDEA), SEAL, DESX, RC5, BLOWFISH, CAST128, SAFER, etc., and examples of the asymmetric key include Rivest Shamir Adleman (RSA), EIGamal, an elliptic curve crypto system (ECC), a digital signature standard (DSS), public key partners (PKP), etc. Of course, the symmetric key and the asymmetric key are not limited to the above examples, and information used for a symmetric encryption/decryption method or an asymmetric encryption/decryption method not described above may also be included in the symmetric key or the asymmetric key.

The web server 400 may be a server or a device that provides an online service to a user. The web server 400 may receive a request for service provision from the client 100 and request user authentication from the client 100 to provide the service. Here, the user authentication procedure may be performed through the personal information authentication server 200 in addition to the web server 400 itself.

When the user authentication procedure for providing the service of the web server 400 is performed through the personal information authentication server 200, the web server 400 and the personal information authentication server 200 may perform the authentication procedure through a single sign on system or the like using protocols such as OAuth.

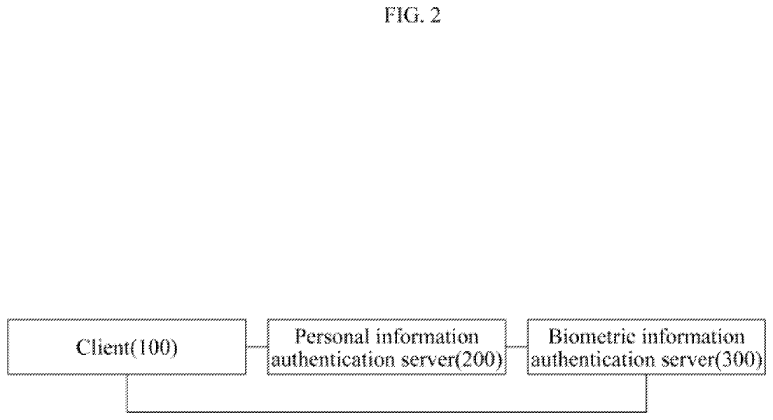

FIG. 2 is a diagram illustrating a relationship between the client, the personal information authentication server, and the biometric information authentication server according to an embodiment.

Referring to FIG. 2, when the authentication system 1 is implemented in some embodiments, a registration operation and an authentication operation may be performed. Here, the authentication operation is an operation of confirming whether a user of the biometric information is a user of the biometric information pre-stored in the biometric information authentication server 300, and the registration operation is a pre-operation for performing the authentication operation.

In the registration operation, the biometric information authentication server 300 is designated as a server to store biometric information for registration in the client 100, and the personal information authentication server 200 may be designated as a server to stores a decryption key for biometric information. In addition, in the biometric information authentication server 300 and the personal information authentication server 200, the client 100 may be designated as a device requesting user authentication. In this case, the number of clients 100 may be one or a plural number.

Accordingly, the client 100 receives user authentication through communication with pre-designated servers rather than through anonymous servers, thus improving the security of the user authentication.

In addition, in the registration operation, the client 100 may provide biometric information for registration to the biometric information authentication server 300. To this end, the client 100 may acquire biometric information for registration from a user, encrypt the acquired biometric information for registration using a unique encryption key, and then provide the encrypted biometric information for registration to the biometric information authentication server 300. Here, the biometric information for registration may be directly transmitted from the client 100 to the biometric information authentication server 300 or may be transmitted through the personal information authentication server 200. That is, the biometric information authentication server 300 may acquire the encrypted biometric information for registration.

In addition, the decryption key for the biometric information for registration encrypted in the registration operation may be transmitted from the client 100 to the personal information authentication server 200 and stored. A decryption procedure of the encrypted registration biometric information using the decryption key will be described below.

In addition, in the registration operation, the client 100 may designate the personal information authentication server 200 as a server that stores personal information and may designate the biometric information authentication server 300 as a server that stores a personal information protection key for releasing the protection of the personal information. In addition, in the biometric information authentication server 300 and the personal information authentication server 200, the client 100 may be designated as a device that requests user authentication. In this case, the number of clients 100 may be one or a plural number.

In addition, in the registration operation, the client 100 may provide personal information for registration to the personal information authentication server 200. To this end, after acquiring the personal information for registration from a user and protecting the acquired personal information for registration using a unique protection key, the encrypted personal information for registration may be transmitted to the personal information authentication server 200.

In addition, the protection key for the personal information for registration protected in the registration operation may be provided to and stored in the biometric information authentication server 300. The procedure of releasing the protection of the personal information for registration protected using the protection key will be described below.

Prior to performing the above-described registration operation, a reliability confirmation procedure between the devices or servers may be first performed in order to prevent a device or a server that is not registered or authenticated from accessing the personal information. When the personal information authentication server 200 acquires a user authentication request from the client 100, the client 100 and the personal information authentication server 200 may confirm mutual reliability to see whether the client 100 and the personal information authentication server 200 are mutually reliable devices. In this case, the personal information authentication server 200 and the biometric information authentication server 300 may also confirm mutual reliability to see whether the personal information authentication server 200 and the biometric information authentication server 300 are mutually reliable servers or devices. In addition, similarly, the client 100 and the biometric information authentication server 300 may also confirm mutual reliability to see whether the client 100 and the biometric information authentication server 300 are mutually reliable servers or devices. In this case, the order of confirming the mutual reliability between the servers or devices is not limited. The safety for security may be enhanced by performing an operation of confirming the mutual reliability before the registration operation. The detailed reliability confirmation procedure will be described below.

In the authentication operation, the client 100 may acquire and encrypt the biometric information for authentication, and provide the encrypted biometric information for authentication to the personal information authentication server 200. In addition, the personal information authentication server 200 may provide the encrypted biometric information for authentication acquired from the client 100 to the biometric information authentication server 300. Alternatively, the client 100 may acquire and encrypt the biometric information for authentication, and directly provide the encrypted biometric information for authentication to the biometric information authentication server 300. In addition, the personal information authentication server 200 may transmit the decryption key for the encrypted biometric information for authentication to the biometric information authentication server 300. The procedure of transmitting the decryption key for the encrypted biometric information for authentication will be described below. The biometric information authentication server 300 may decrypt the encrypted biometric information for authentication and biometric information for registration using the decryption key, match the decrypted biometric information for authentication and biometric information for registration, and then provide the matching result to the personal information authentication server 200 or the client 100. Thereafter, when the matching result indicates that the decrypted biometric information for authentication and biometric information for registration match, the biometric information authentication server 300 may provide the protection key capable of releasing the protection of the protected personal information for registration to the personal information authentication server 200. That is, the personal information authentication server 200 may acquire the protection key capable of releasing the protection of the protected personal information for registration only when the biometric information authentication server 300 matches the decrypted biometric information for authentication and biometric information for registration. The personal information authentication server 200 may provide the information indicating that the user has been authenticated and the personal information whose protection has been released to the client 100 or the web server 400, and when there is no match, may provide the information indicating that the user has not been authenticated to the client 100 or the web server 400.

In addition, the client 100 may receive a user input and request the web server 400 to provide a service. In this case, the web server 400 may request a user authentication procedure from the client 100 to perform the above-described authentication operation so that the user can be authenticated by the authentication system 1.

As described above, when the user authentication procedure of the web server 400 is performed through the personal information authentication server 200, the web server 400 allows the client 100 to access the personal information authentication server 200. In this case, the personal information authentication server 200 may request a user to input information for user authentication to the client 100. Here, the information for user authentication may be the biometric information acquired from the client 100 according to the authentication request, the user's personal information, or the like. Hereinafter, the biometric information for user authentication may be referred to as the biometric information for authentication, and the personal information for user authentication may be referred to as the personal information for authentication.

When the biometric information for authentication or the personal information for authentication is acquired from the client 100, the personal information authentication server 200 may transmit the acquired biometric information to the biometric information authentication server 300 for the biometric information authentication server 300 to perform the user authentication procedure.

Here, after the reliability confirmation procedure between the above-described devices or servers is completed, the user authentication procedure may be performed only between the devices or servers whose reliability has been confirmed.

When the biometric authentication process is completed in the biometric information authentication server 300 and the user authentication is confirmed, the personal information authentication server 200 may receive the authentication result and the protection key for releasing the protection of the protected personal information from the biometric information authentication server 300.

The personal information authentication server 200 may release the protection of the stored personal information for registration using the personal information protection key. The personal information for registration whose protection has been released may be provided to each client 100 or web server 400 according to the request of the client 100 or the web server 400 to provide a service.

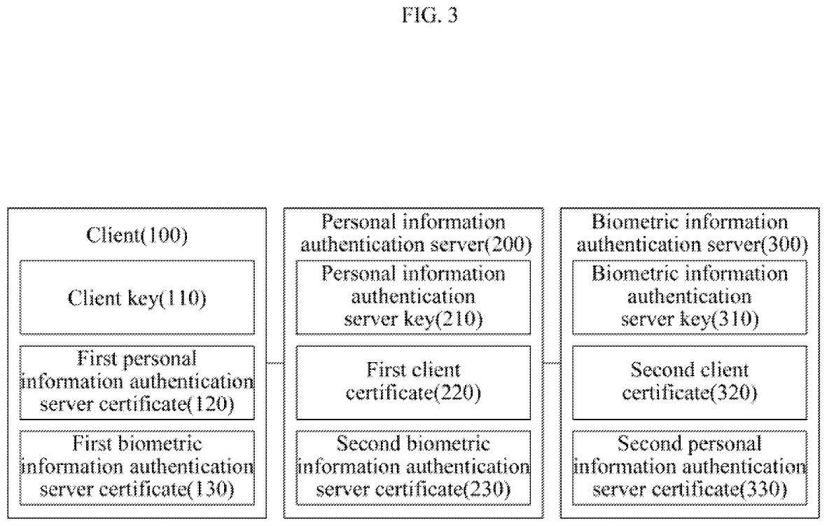

FIG. 3 is a diagram for describing a method of confirming reliability according to an embodiment of the present invention.

Referring to FIG. 3, the client 100, the personal information authentication server 200, and the biometric information authentication server 300 may store unique keys (private keys) for each device or server used in the reliability confirmation procedure of each device or server and certificates of devices or servers different therefrom. Each private key is a key used in an asymmetric encryption algorithm such as RSAIECC, and when the private keys are generated or input using a device such as a hardware security module (HSM), it is possible to confirm validity of a key value stored in the other server through a public key while avoiding threats of changing or extracting the private keys. The method of confirming reliability is the same as the method, procedure, and idea used for authenticating validity of domain addresses between servers in the hypertext transfer protocol over Secure Sockets Layer (HTTPS) protocol. However, the reliability relationship may be arbitrarily broken or added by an independent certification authority or a self-certification procedure in addition to the method of confirming mutual reliability by a signature by a third authority, and therefore, greater flexibility and scalability can be provided compared to the HTTPS protocol.

More specifically, the client 100 may store the client key 110, which is a unique private key used for proving the reliability of the client. Each of the plurality of clients may store different private keys 110. However, in some cases, a plurality of clients may store the same private key 110.

Hereinafter, the reliability confirmation procedure between the client 100, the personal information authentication server 200, and the biometric information authentication server 300 will be described.

When the client 100 requests the web server 400 to provide a service and attempts to perform the user authentication procedure of the client 100 through the personal information authentication server 200 in the web server 400, the client 100 may provide the client key 110 to the personal information authentication server 200 and/or the biometric information authentication server 300 to allow the personal information authentication server 200 and/or the biometric information authentication server 300 to confirm the reliability of the client 100. In this case, the personal information authentication server 200 and/or the biometric information authentication server 300, which has received the client key 110, may confirm the reliability of the client 100 requesting the reliability confirmation using a first client certificate 220 and/or a second client certificate 320 and the client key 110 that are previously provided from the client 100 and stored in each server or device.

In addition, the client 100 may receive the personal information authentication server key 210 from the personal information authentication server 200. In this case, the client 100 may perform a procedure of confirming the reliability of the personal information authentication server 200 using a first personal information authentication server certificate 120 pre-stored in the client 100 and the received personal information authentication server key 210.

In addition, the client 100 may receive a biometric information authentication server key 310 from the biometric information authentication server 300. In this case, the client 100 may perform a procedure of confirming the reliability of the biometric information authentication server 300 using a first biometric information authentication server certificate 130 pre-stored in the client 100 and the received biometric information authentication server key 310.

Similar to the procedure for the client 100 to confirm the reliability of the personal information authentication server 200 and/or the biometric information authentication server 300, the personal information authentication server 200 may also perform a procedure of confirming the reliability of the client 100 and/or the biometric information authentication server 300.

In this case, the personal information authentication server 200 may provide the personal information authentication server key 210 to the client 100 and/or the biometric information authentication server 300 to allow the client 100 and/or the biometric information authentication server 300 to confirm the reliability of the personal information authentication server 200. In this case, the client 100 and/or the biometric information authentication server 300 receiving the personal information authentication server key 210 may be previously provided from the personal information authentication server 200 to confirm the reliability of the personal information authentication server 200 requesting the reliability confirmation by using the first personal information authentication server certificate 120 and/or a second personal information authentication server certificate 330 which is stored in each server or device.

In addition, the personal information authentication server 200 may receive the client key 110 from the client 100. In this case, the personal information authentication server 200 may perform a procedure of confirming the reliability of the client 100 using the first client certificate 220 pre-stored in the personal information authentication server 200 and the received client key 110.

In addition, the personal information authentication server 200 may receive the biometric information authentication server key 310 from the biometric information authentication server 300. In this case, the personal information authentication server 200 may perform a procedure of confirming the reliability of the biometric information authentication server 300 using a second biometric information authentication server certificate 230 pre-stored in the personal information authentication server 200 and the received biometric information authentication server key 310.

Similar to the method of performing the reliability confirmation procedure of the client 100 or the personal information authentication server 200, the biometric information authentication server 300 may also perform a procedure of confirming the reliability of the client 100 and/or the personal information authentication server 200.

In this case, the biometric information authentication server 300 may provide the biometric information authentication server key 310 to the client 100 and/or the personal information authentication server 200, and the client 100 and/or the personal information authentication server 200 may confirm the reliability of the biometric information authentication server 300. In this case, the client 100 and/or the personal information authentication server 200 receiving the biometric information authentication server key 310 may be previously provided from the biometric information authentication server 300 to confirm the reliability of the personal information authentication server 200 requesting the reliability confirmation by using the first biometric information authentication server certificate 130 and/or the second biometric information authentication server certificate 230 which is stored in each server or device.

In addition, the biometric information authentication server 300 may receive the client key 110 from the client 100. In this case, the biometric information authentication server 300 may perform a procedure of confirming the reliability of the client 100 using the second client certificate 320 pre-stored in the biometric information authentication server 300 and the received client key 110.

In addition, the biometric information authentication server 300 may receive the personal information authentication server key 210 from the personal information authentication server 200. In this case, the biometric information authentication server 300 may perform a procedure of confirming the reliability of the personal information authentication server 200 using the second personal information authentication server certificate 330 pre-stored in the biometric information authentication server 300 and the received personal information authentication server key 210.

It may be understood that the reliability confirmation procedure through the unique keys 110, 210, and 310 of each server or device and the certificates 120, 130, 220, 230, 320, and 330 provided to and stored in each server or device in advance may be used in a variety of ways within a range that is apparent to those skilled in the art to which the present invention belongs,

As described above, by going through the operation of confirming the mutual reliability between the servers or devices, when any one device or server in the authentication system 1 is exposed to the risk of hacking, each server or device may not pass through the reliability confirmation procedure, and thus the authentication operation by the authentication system 1 is not performed normally. As a result, the security of the user authentication process by the authentication system 1 can be enhanced.

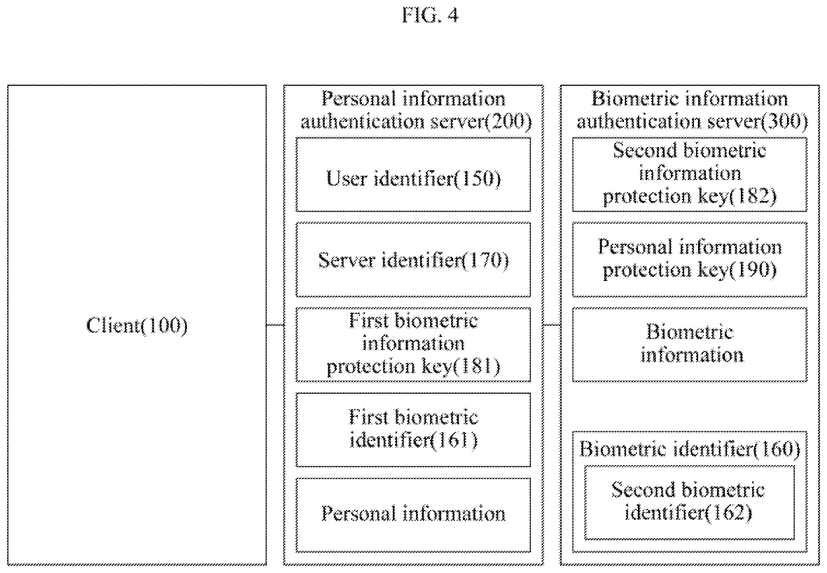

FIG. 4 is a diagram illustrating an authentication procedure according to the embodiment of the present invention.

Referring to FIG. 4, a user identifier 150 for identifying the client 100 may be stored in the personal information authentication server 200. The user identifier 150 may be stored in the personal information authentication server 200, and the personal information authentication server 200 may identify the user or the client 100 when the client 100 requests the user authentication.

More specifically, in the process in which the client 100 acquires and registers the user's biometric information in the above-described registration operation, the client 100 may provide the user identifier 150 to the personal information authentication server 200 to be stored in the personal information authentication server 200. In this case, the user identifier 150 may be used for identifying the biometric information for registration of the client 100 and/or the user corresponding to the user identifier 150. In addition, the user identifier 150 may be used for identifying the personal information for registration of the user corresponding to the user identifier 150.

In the above-described authentication process, when the client 100 requests the user authentication, the personal information authentication server 200 may confirm whether the client 100 requesting the user authentication is the user and/or the client 100 corresponding to the user identifier 150. In addition, when it is confirmed that the client 100 requesting the user authentication is the client 100 and/or the user corresponding to the user identifier 150, the authentication procedure for the biometric information for registration or the personal information for registration corresponding to the user identifier 150 may be performed in the authentication system 1.

Referring to FIG. 4, a biometric identifier 160 may be stored in the personal information authentication server 200. The biometric identifier 160 may be stored in the personal information authentication server 200, and when the client 100 requests the user authentication, the biometric identifier 160 may allow the biometric information authentication server 300 to perform the authentication procedure through the biometric information for registration and the biometric information for authentication corresponding to the biometric identifier 160.

More specifically, in the process in which the client 100 acquires and registers the user's biometric information in the above-described registration operation, when the personal information authentication server 200 transmits the biometric information for registration to the biometric information authentication server 300, the biometric information authentication server 300 may generate the biometric identifier 160 corresponding to the biometric information for registration. The generated biometric identifier 160 may be allocated from the biometric information authentication server 300 to the personal information authentication server 200, may be stored in the personal information authentication server 200, and may also be stored in the biometric information authentication server 300. The biometric identifier 160 may be generated to correspond to the user identifier 150. Here, the biometric identifier allocated to and stored in the personal information authentication server 200 from the biometric information authentication server 300 may be referred to as a first biometric identifier 161, and the biometric identifier stored in the biometric information authentication server 300 may be referred to as a second biometric identifier 162.

In the above-described authentication process, when the client 100 requests the user authentication to transmit the user identifier and the biometric information for authentication to the personal information authentication server, the operation of extracting the first biometric identifier 161 corresponding to the user identifier 150 from the personal information authentication server 200 may be performed. The extracted first biometric identifier 161 may be transmitted to the biometric information authentication server 300. The first biometric identifier transmitted to the biometric information authentication server 300 may be used for extracting the biometric information for registration corresponding to the first and second biometric identifiers 161 and 162 as the biometric information authentication server 300 uses the first biometric identifier 161 and the second biometric identifier 162.

Referring to FIG. 4, a server identifier 170 may be stored in the personal information authentication server 200. The server identifier 170 may be stored in the personal information authentication server 200, and when the user authentication procedure is performed in the authentication system 1, the biometric information authentication server 300 may be used for identifying the personal information authentication server 200.

More specifically, in the registration operation, when biometric information for registration is transmitted from the personal information authentication server 200 to the biometric information authentication server 300, the server identifier 170 may be provided so that the biometric information authentication server 300 can identify the personal information authentication server 200 that has transmitted biometric information for registration.

In the authentication operation, when the client 100 requests the user authentication to allow the personal information authentication server 200 to transmit the server identifier 170 to the biometric information authentication server 300, the biometric information authentication server 300 may confirm and identify the personal information authentication server 200 corresponding to the server identifier 170. In this case, the biometric information authentication server 300 may extract only the second biometric identifier 162 provided from the personal information authentication server 200 corresponding to the server identifier 170 to perform a subsequent biometric information authentication process. More specifically, when the server identifier 170 is transmitted, the biometric information authentication server 300 may extract a plurality or one second biometric identifier corresponding to the server identifier, and later extract the second biometric identifier corresponding to the first biometric identifier among the extracted second biometric identifiers when the first biometric identifier is transmitted from the personal information authentication server 200. Thereafter, the biometric information authentication procedure may be performed using the corresponding first and second biometric identifiers 161 and 162 and the corresponding biometric information for registration.

Referring to FIG. 4, the personal information authentication server 200 may store a first biometric information decryption key 181. The first biometric information decryption key 181 is stored in the personal information authentication server 200 and transmitted to the biometric information authentication server 300 when the user biometric authentication procedure proceeds and thus may be used for decrypting the encrypted biometric Information for registration and/or authentication.

More specifically, in the registration operation, when the biometric information for registration is input to the client 100, encrypted with a unique encryption key of the client 100, and transmitted to the personal information authentication server 200, the first biometric information decryption key 181 may be generated by the client 100 and transmitted to and stored in the personal information authentication server 200 or may be generated by and directly stored in the personal information authentication server 200.

In the authentication operation, when the identification operation is performed through the server identifier 170 and/or the biometric identifier 160, the first biometric information decryption key 181 corresponding to the first biometric identifier 161 among the plurality of biometric information decryption keys may be provided to the biometric information authentication server 300. In this case, the biometric information authentication server 300 may decrypt the encrypted biometric information for registration and/or authentication using the received first biometric information decryption key 181.

In addition, the second biometric information decryption key 182 may be stored in the biometric information authentication server 300. The second biometric information decryption key 182 may enable the first biometric information decryption key 181 corresponding to the second biometric Information decryption key to be transmitted to the biometric information authentication server 300. Specifically, the second biometric information decryption key 182 is used for receiving the first biometric information decryption key 181, and it may be preferable that the authentication server not include information for decrypting the biometric information for registration or the biometric information for authentication stored in the biometric information authentication server 300. This is because when the information for decrypting the encrypted biometric information and the encrypted biometric information are in the same server, the security risk may increase.

Specifically, in the registration operation, when the first biometric information decryption key 181 is generated, the second biometric information decryption key 182 corresponding to the first biometric information decryption key 181 may be generated in the personal information authentication server 200 or the client 100. The generated second biometric information decryption key 182 may be transmitted to and stored in the biometric information authentication server 300.

In the authentication operation, when the personal information authentication server 200 requests to transmit the first biometric information decryption key 181 to the biometric information authentication server 300, the biometric information authentication server 300 may determine whether the second biometric information decryption key 182 corresponding to the first biometric information decryption key 181 is stored in the biometric information authentication server 300, and when the second biometric information decryption key corresponding to the first biometric information decryption key 181 is stored, the biometric information authentication server 300 may receive the first biometric information decryption key 181 to perform the encrypted biometric information for registration and/or authentication.

According to an embodiment, the first biometric information decryption key and the second biometric information decryption key may be keys obtained by dividing the biometric information decryption key 180 for the encrypted biometric information for registration and/or authentication. That is, the first biometric information decryption key and the second biometric information decryption key may each not be used for decrypting the encrypted biometric information but may be combined to generate a complete decryption key.

According to an embodiment, the second biometric information decryption key 182 may be encrypted and the first biometric information decryption key 181 may be used for decrypting the encrypted second biometric information decryption key 182. The encrypted biometric information for registration and/or authentication may be decrypted using the second biometric information decryption key 182 decrypted by the first biometric information decryption key 181.

Referring to FIG. 4, the biometric information authentication server 300 may store a personal information protection key 190. The personal information protection key 190 may be stored in the biometric information authentication server 300, transmitted to the personal information authentication server 200 when the user's biometric authentication process is completed, and used for releasing the protection of the protected user's personal information.

More specifically, as described above in the registration operation, when the user's personal information is stored in the personal information authentication server 200 and biometric information for registration is provided to the biometric information authentication server 300, the personal information protection key 190 corresponding to the user's personal information stored in the personal information authentication server 200 may be transmitted from the personal information authentication server 200 to the biometric information authentication server 300 and stored.

In the authentication operation, as described above, when the encrypted biometric information for registration and/or authentication is decrypted and the user biometric authentication procedure is completed to confirm the user authentication, the biometric information authentication server 300 may transmit the personal information protection key 190 for releasing the protection of the user's protected personal information stored in the personal information authentication server 200 to the personal information authentication server 200. The personal information authentication server 200 may release the protection of the protected personal information using the received personal information protection key 190 and provide the personal information of the user whose protection is released to the web server 400 and/or the client 100 to allow a user to receive services using the personal information.

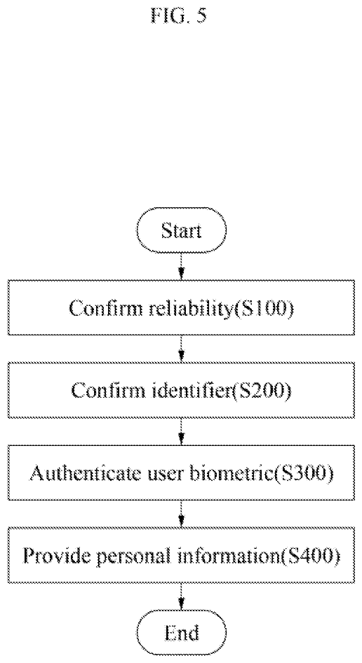

FIG. 5 is a diagram illustrating an authentication process by an authentication system according to the embodiment of the present invention.

Referring to FIG. 5, the authentication method of the authentication system according to the embodiment may include a reliability confirmation operation (S100), an identifier confirmation operation (S200), a user biometric authentication operation (S300), and a personal information provision operation (S400).

The authentication method using the authentication system 1 according to the embodiment may be started by first requesting the client 100 to provide a service. The client 100 may directly request the web server 400 or the personal information authentication server 200 to provide an online service desired by the user.

When the client 100 requests the web server 400 to provide a service, the web server 400 allows the client 100 to access the personal information authentication server 200 in order to delegate the user authentication procedure to the personal information authentication server 200, thereby performing the user authentication.

When the web server 400 allows the client 100 to access the personal information authentication server 200 in order to perform the user authentication procedure, the client 100, the personal information authentication server 200, and/or the biometric information authentication server 300 may perform the reliability confirmation operation (S100) to confirm whether each device and/or server is a reliable device and/or server.

In the reliability confirmation operation (S100), as described above, the client 100 may transmit the client key 110 to the personal information authentication server 200 and the biometric information authentication server 300, and receive the personal information authentication server key 210 and the biometric information authentication server key 310 from the personal information authentication server 200 and the biometric information authentication server 300. The client 100 may confirm the reliability of the personal information authentication server 200 using the pre-stored first personal information authentication server certificate 120 and the received personal information authentication server key 210. Further, the client 100 may confirm the reliability of the biometric information authentication server 300 using the pre-stored first biometric information authentication server certificate 130 and the received biometric information authentication server key 310. The client 100 may first confirm the reliability of the personal information authentication server 200 and may first confirm the reliability of the biometric Information authentication server 300.

In addition, as described above, the personal information authentication server 200 may transmit the personal information authentication server key 210 to the client 100 and the biometric information authentication server 300 and receive the client key 110 and the biometric information authentication server key 310 from the biometric information authentication server 300. The personal information authentication server 200 may confirm the reliability of the client 100 using the pre-stored first client certificate 220 and the received client key 110. Further, the personal information authentication server 200 may confirm the reliability of the biometric information authentication server 300 using the pre-stored second biometric information authentication server certificate 230 and the received biometric information authentication server key 310. The personal information authentication server 200 may first confirm the reliability of the client 100 and may first confirm the reliability of the biometric information authentication server 300.

In addition, as described above, the biometric information authentication server 300 may transmit the biometric information authentication server key 310 to the client 100 and the personal information authentication server 200, and receive the client key 110 and the personal information authentication server key 210 from the client 100 and the personal information authentication server 200. The biometric information authentication server 300 may confirm the reliability of the client 100 using the pre-stored second client certificate 320 and the received client key 110. In addition, the biometric information authentication server 300 may confirm the reliability of the personal information authentication server 200 using the pre-stored personal information authentication server certificate 330 and the received personal information authentication server key 210. The biometric information authentication server 300 may first confirm the reliability of the client 100 and may first confirm the reliability of the personal information authentication server 200.

In addition, according to an embodiment, in the authentication method of the authentication system 1, the above-described reliability confirmation operation between the servers or devices may be performed simultaneously or sequentially.

According to another embodiment, in the operation of confirming the reliability of the authentication system 1, the client key 110 stored in the client 100 may be periodically updated. In addition, even when the access of another client or server whose reliability has not been authenticated to the personal information authentication server 200 or the biometric information authentication server 300 is detected while the authentication procedure proceeds, the client key 110 stored in the client 100 may be updated.

Similarly, the personal information authentication server key 210 stored in the personal information authentication server 200 may be periodically updated. In addition, even when the access of other devices or servers whose reliability has not been authenticated to the client 100 or the biometric information authentication server 300 is detected while the authentication procedure proceeds, the personal information authentication server key 210 stored in the personal information authentication server 200 may be updated.

The biometric information authentication server key 310 stored in the biometric information authentication server 300 may be periodically updated. In addition, even when the access of other devices or servers whose reliability has not been authenticated to the client 100 or the personal information authentication server 200 is detected while the authentication procedure proceeds, the biometric information authentication server key 310 stored in the biometric information authentication server 300 may be updated to enhance security.

Similar to the procedure of updating a unique key held by each device or server, the certificates of other devices or servers held by each device or server may also be updated periodically.

In addition, when the access of other servers or devices whose reliability has not been confirmed to the client 100 is detected, the first personal information authentication server certificate 120 or the first biometric information authentication server certificate 130 stored in the client 100 may be updated to enhance security.

In addition, when the access of the server or the device whose reliability has not been confirmed to the personal information authentication server 200 is detected, the first client certificate 220 or the second biometric information authentication server certificate 230 stored in the personal information authentication server 200 may be updated to enhance security.

In addition, when the access of the server or the device whose reliability has not been confirmed to the biometric information authentication server 300 is detected, the second client certificate 320 or the second personal information authentication server certificate 330 stored in the biometric information authentication server 300 may be updated to enhance security.

Here, the device or the server whose reliability has not been confirmed may be interpreted as a server or a device other than those constituting the authentication system 1. In addition, the device or the server whose reliability has not been confirmed may be a device or server that has never exchanged information with the client 100, the personal information authentication server 200, or the biometric information authentication server 300.

Through the certificate updating procedure as described above, when any one device or server in the above-described authentication system 1 is exposed to the risk of hacking, the authentication operation is not properly performed, and the effect of doubly enhancing security may be derived.

In the authentication method of the authentication system 1, after the reliability confirming procedure between the devices or servers is completed, when the reliability between the devices or the servers is confirmed, the identifier confirmation operation (S200) may be performed.

In the identifier confirmation operation (S200), when a user provides a service to the web server 400 through the client 100, the user identifier 150 may be transmitted from the client 100 to the web server 400. The web server 400 may transmit the user identifier 150 to the personal information authentication server 200 for delegating the user authentication procedure to proceed with the user authentication procedure. When the user identifier 150 is transmitted, the personal information authentication server 200 may extract information corresponding to the transmitted user identifier 150 from among the information related to the pre-stored user identifiers. The information corresponding to the user identifier 150 may be all information related to the user including the above-described biometric identifier 160, server identifier 170, first biometric information decryption key 181, and/or protected personal information, or the like.

After the identification operation by the user identifier 150 is performed, the server identifier 170 may be transmitted from the personal information authentication server 200 to the biometric information authentication server 300. When the server identifier 170 is received, the biometric information authentication server 300 may extract the information corresponding to the server identifier 170. The personal information authentication server 170 corresponding to the server identifier 170 may be identified using the server identifier 170, and the information transmitted from the identified personal information authentication server 200 and stored in the biometric information authentication server 300 may be extracted. The information corresponding to the server identifier 170 may be information stored in the biometric information authentication server 300 that includes the above-described biometric identifier 160, first biometric information decryption key 181, and/or encrypted biometric information, or the like. The biometric information authentication server 300 receiving the server identifier 170 may provide a signal indicating that the personal information authentication server 200 corresponding to the server identifier 170 has been identified to the personal information authentication server 200.

After the identification operation by the server identifier 170 is performed, the personal information authentication server 200 may transmit the biometric identifier 160 to the biometric information authentication server 300. When the biometric identifier 160 is transmitted, the biometric information authentication server 300 may extract the encrypted biometric information for registration corresponding to the biometric identifier 160 from among the pre-stored information corresponding to the server identifier 170 to complete the preparation process for the biometric authentication.

In the authentication method of the authentication system 1, when the identifier confirmation operation is completed, the user biometric authentication operation (S300) may be performed.

In the user biometric authentication operation (S300), first, the encrypted biometric information for authentication collected in the client 100 may be transmitted to the biometric information authentication server 300 directly from the client 100 or through the personal information authentication server 200. In addition, the first biometric information decryption key 181 may also be transmitted to the biometric information authentication server 300 together with or separately from the encrypted biometric information for authentication.

According to an embodiment, when the second biometric information decryption key 182 corresponding to the first biometric information decryption key 181 is not stored in the biometric information authentication server 300, the first biometric information decryption key 181 may not be transmitted to the biometric information authentication server 300.

The biometric information authentication server 300 may receive the encrypted biometric information for authentication and decrypt the encrypted biometric information for registration and biometric information for authentication corresponding to the server identifier 170 and the biometric identifier 60 using the first biometric information decryption key 181.

According to an embodiment, the biometric information authentication server 300 may decrypt the encrypted biometric information for registration and biometric information for authentication using both the first biometric information decryption key 181 and the second biometric information decryption key 182.

In addition, according to an embodiment, the first biometric information decryption key 181 may be a key encrypted using a private key or the like and may be extracted from the second biometric information decryption key 182.

When the decryption of the encrypted biometric information for registration and the encrypted biometric information for authentication is completed, the biometric information authentication server 300 may match the decrypted biometric information for registration and biometric information for authentication for the biometric authentication.

When the matching result indicates that the decrypted biometric information for authentication and biometric information for registration match, the biometric information authentication server 300 may transmit the matching result indicating that the decrypted biometric information for authentication and biometric information for registration match and the personal information protection key 190 pre-stored in the biometric information authentication server 300 to the personal information authentication server 200.

In addition, when the matching result indicates that the decrypted biometric information for authentication and biometric information for registration match, the biometric information authentication server 300 may transmit the matching result indicating that the decrypted biometric information for authentication and biometric information for registration match to the client 100.

When the matching result indicates that the decrypted biometric Information for authentication and biometric information for registration do not match, the biometric information authentication server 300 may transmit the matching result indicating that the decrypted biometric information for authentication and biometric information for registration do not match to the personal information authentication server 200 and may not transmit the personal information protection key 190.

In addition, when the matching result indicates that the decrypted biometric information for authentication and biometric information for registration do not match, the biometric information authentication server 300 may transmit the matching result indicating that the decrypted biometric information for authentication and biometric information for registration do not match to the client 100.

When the biometric information authentication procedure is completed, the authentication system 1 may perform the personal information provision operation (S400).

In the personal information provision operation (S400), when the personal information authentication server 200 acquires the matching result indicating that the decrypted biometric information for authentication and biometric information for registration match, the personal information authentication server 200 receiving the personal information protection key 190 first may release the protection of the personal information for registration corresponding to the user identifier 150 extracted in the identifier confirmation operation by using the personal information protection key 190 received from the biometric information authentication server 300 in the biometric authentication operation.

When the release of the protection of the personal information for registration is completed, the personal information authentication server 200 may provide the client 100 and/or the web server 400 with the result that the user authentication has been completed and the personal information whose protection has been released.

According to an embodiment, when the personal information authentication server acquires the matching result indicating that the decrypted biometric information for authentication and biometric information for registration do not match the result of biometric authentication, the personal information authentication server 200 may transmit only the result that the user authentication has failed to the client 100 or the web server 400.

The method according to the embodiment may be implemented in the form of program commands that can be executed through various computer units and may be recorded in a computer-readable recording medium. The computer-readable recording medium may include a program command, a data file, a data structure or the like alone or a combination thereof. The program commands recorded on the medium may be especially designed and configured for the embodiments or known to those skilled in the field of computer software. Examples of the computer-readable recording medium may include a magnetic medium such as a hard disk, a floppy disk, or a magnetic tape, an optical medium such as a compact disc read only memory (CD-ROM) or a digital versatile disc (DVD), a magneto-optical medium such as a floptical disk; and a hardware device specially configured to store and execute program commands, such as a ROM, a RAM, a flash memory, or the like. Examples of the program commands include a high-level language code capable of being executed by a computer using an interpreter, or the like, as well as a machine language code made by a compiler. The above-described hardware device may be constituted to be operated as one or more software modules to perform the operations of the embodiments, and vice versa.

Although embodiments have been described above with reference to a limited number of drawings, various modifications and alternations are possible for those of ordinary skill in the art based on the above description. For example, even when the described techniques are performed in an order different from that in the described method, and/or components of the described systems, structures, devices, circuits, etc. are coupled or combined in a different manner than in the described method, or replaced or substituted with other components, appropriate results can be achieved.

Therefore, other implementations, other embodiments, and equivalents to the claims also fall within the scope of the claims described below.

What is claimed is:

1. A method of controlling a personal information authentication server in an authentication system, wherein the authentication system includes a biometric information authentication server that stores biometric information for registration acquired from each of one or more clients and performs matching between biometric information for authentication and the biometric information for registration, a target client that is included in the one or more clients and acquires the biometric information for authentication of a user, and a personal information authentication server that stores pieces of personal information acquired by each of the one or more clients, the method comprises:
confirming mutual reliability with the target client before performing a biometric information authentication procedure;
acquiring the biometric information for authentication from the target client after the mutual reliability with the target client is confirmed;
confirming mutual reliability with the biometric information authentication server;
providing the biometric information for authentication to the biometric information authentication server such that the biometric information authentication procedure is performed on the biometric information authentication server when the mutual reliability with the biometric information authentication server is confirmed;
acquiring a personal information protection key from the biometric information authentication server for releasing protection of personal information corresponding to the target client among the pieces of stored personal information when the authentication is completed in the biometric information authentication procedure; and
decrypting the personal information using the personal information protection key or authenticating a right to use such that the personal information is confirmed by a server or a device in which the mutual reliability with the personal information authentication server is confirmed.

2. The method of claim 1, wherein the confirming mutual reliability with the target client before performing the biometric information authentication procedure is performed by exchanging of mutual certificates with the target client.

3. The method of claim 2, wherein, when reliability of the target client or the personal information authentication server is not confirmed, at least one of the certificates held by the target client or the personal information authentication server is updated.

4. The method of claim 1, wherein, the confirming mutual reliability with the biometric information authentication server is performed before the biometric information authentication procedure is performed, and is performed by exchanging of certificates with the biometric information authentication server.

5. The method of claim 3, wherein, when reliability of the biometric information authentication server or the personal information authentication server is not confirmed, at least one of the certificates held by the biometric information authentication server or the personal information authentication server is updated.

6. A method of controlling a personal information authentication server in an authentication system, wherein the authentication system includes a biometric information authentication server that stores biometric information for registration acquired from each of one or more clients and performs matching between biometric information for authentication and the biometric information for registration, a target client that is included in the one or more clients and acquires the biometric information for authentication of a user, and a personal information authentication server that stores pieces of personal information acquired by each of the one or more clients, the method comprises:
confirming mutual reliability with the biometric information authentication server;
acquiring a personal information protection key from the biometric information authentication server for releasing protection of personal information corresponding to the target client among the pieces of stored personal information when the mutual reliability with the biometric information authentication server is confirmed; and
decrypting the personal information using the personal information protection key or authenticating a right to use such that the personal information is confirmed by a server or a device in which the mutual reliability with the personal information authentication server is confirmed,
wherein the acquiring the personal information protection key is performed after a biometric information authentication procedure in which the biometric information for authentication is transmitted form the target client to the biometric information authentication server, wherein the biometric information authentication procedure is performed after the mutual reliability of the target client and the biometric information authentication server is confirmed by completing a mutual reliability confirmation procedure between the target client and the biometric information authentication server.

7. The method of claim 6, wherein the mutual reliability confirmation procedure between the target client and the biometric information authentication server is performed by exchanging certificates with the target client.

8. The method of claim 7, wherein, in the mutual reliability confirmation procedure of the target client or the biometric information authentication server, when reliability of the target client or the biometric information authentication server is not confirmed, at least one of the certificates held by the target client or the biometric information authentication server is updated.

9. A method of controlling a biometric information authentication server in an authentication system, wherein the authentication system includes a biometric information authentication server that stores biometric information for registration acquired from each of one or more clients and performs matching between biometric information for authentication and the biometric information for registration, a target client that is included in the one or more clients and acquires the biometric information for authentication of a user, and a personal information authentication server that stores personal information acquired by each of the one or more clients, the method comprises:
confirming mutual reliability with the target client before performing a biometric information authentication procedure;
confirming mutual reliability with the personal information authentication server before performing a biometric information authentication procedure;
acquiring the biometric information for authentication, a biometric information decryption key, and a biometric identifier after the mutual reliability between the target client and the personal information authentication server is confirmed;
decrypting the biometric information by extracting the biometric information for registration corresponding to the biometric identifier when the reliability of the personal information authentication server is confirmed;
determining whether the extracted biometric information for registration and the biometric information for authentication match; and
providing a personal information protection key to the personal information authentication server when it is determined that the biometric information for registration and the biometric information for authentication match.

10. The method of claim 9, wherein the confirming mutual reliability with the target client before performing the biometric information authentication procedure is performed by exchanging certificates with the target client.

11. The method of claim 10, wherein when reliability of the target client or the biometric information authentication server is not confirmed, at least one of the certificates held by the target client or the biometric information authentication server is updated.

12. The method of claim 9, wherein, prior to performing the biometric information authentication procedure, the confirming of the mutual reliability with the personal information authentication server is performed through exchange of certificates with the personal information authentication server.

13. The method of claim 9, wherein, when reliability of the personal information authentication server or the biometric information authentication server is not confirmed, at least one of the certificates held by the personal information authentication server or the biometric information authentication server is updated.

14. The method of claim 9, wherein the determining whether the biometric information for registration and the biometric information for authentication match is to determine whether the biometric information for registration and the biometric information for authentication are the same.

15. A recording medium on which a program for executing the method of claim 1 is recorded.
